(19) United States
(12) Patent Application Publication
(10) Pub. No.: US 2023/0011103 A1
(43) Pub. Date: Jan. 12, 2023

(54) INFORMATION PROCESSING APPARATUS, INFORMATION PROCESSING SYSTEM, AND INFORMATION PROCESSING METHOD

(71) Applicant: TOYOTA JIDOSHA KABUSHIKI KAISHA, Aichi-ken (JP)

(72) Inventors: Daiki YOKOYAMA, Gotemba-shi (JP); Toshiya HASHIMOTO, Miyoshi-shi (JP); Katsuya KOBAYASHI, Okazaki-shi (JP); Takahiro HIRANO, Gotemba-shi (JP); Midori SUGIYAMA, Susono-shi (JP); Ryunosuke YAMASHITA, Susono-shi (JP)

(21) Appl. No.: 17/860,115

(22) Filed: Jul. 8, 2022

(30) Foreign Application Priority Data
Jul. 9, 2021 (JP) 2021-114198

(51) Int. Cl. G06Q 30/06

(52) U.S. Cl. CPC G06Q 30/0645; G06Q 30/0627; B60L 53/12

(57) ABSTRACT

An information processing apparatus accepts an inquiry about rental of a power feed mat that can supply electric power to a movable body. In the information processing apparatus, association information in which category information is associated with identification information of each of a plurality of power feed mats is stored. The category information indicates to which of a plurality of categories set for characteristics at least one characteristic of the power feed mat belongs. The information processing apparatus specifies at least one power feed mat among the plurality of power feed mats based on the accepted inquiry and the association information. The information processing apparatus provides information based on a result of specifying.

This nonprovisional application is based on Japanese Patent Application No. 2021-114198 filed with the Japan Patent Office on Jul. 9, 2021, the entire contents of which are hereby incorporated by reference.

### BACKGROUND

### Field

The present disclosure relates to an information processing apparatus, an information processing system, and an information processing method.

### Description of the Background Art

A power feed mat that is portable and can wirelessly charge a vehicle and the like has conventionally been known. For example, Japanese Patent Laying-Open No. 2014-236540 discloses a power transmission coil member including a power transmission coil that transmits electromagnetic waves for power transmission to a power reception coil mounted on a vehicle and a sheet material which is a pliable sheet that covers the power transmission coil. This power transmission coil member is portable.

### SUMMARY

A location where the power feed mat is used or a purpose of use thereof is different depending on a user, and therefore a function desired therefor is different for each user.

An object of the present disclosure is to provide an information processing apparatus, an information processing system, and an information processing method that allow appropriate rental of a power feed mat to a user.

According to one aspect of the present disclosure, an information processing apparatus includes acceptance means for accepting an inquiry about rental of a power feed mat that supplies electric power to a movable body and storage means in which association information in which category information is associated with identification information of each of a plurality of power feed mats is stored. The category information indicates to which of a plurality of categories set for characteristics at least one characteristic of the power feed mat belongs. The information processing apparatus further includes specifying means for specifying at least one power feed mat among the plurality of power feed mats based on the inquiry accepted by the acceptance means and the association information and output means for providing information based on a result of specifying by the specifying means.

According to such a configuration, the information processing apparatus can specify a power feed mat based on the inquiry, among the plurality of power feed mats. Therefore, the power feed mat can appropriately be rented to a user who has made the inquiry.

Preferably, the characteristic is a degree of deterioration. The plurality of categories set for the degree of deterioration include a category in which the degree of deterioration of the power feed mat is equal to or higher than a reference degree and a category in which the degree of deterioration is lower than the reference degree. According to such a configuration, the power feed mat can be rented in accordance with the degree of deterioration.

Preferably, the characteristic is a product specification. The inquiry includes information indicating the product specification. According to such a configuration, the power feed mat can be rented in accordance with the product specification.

Preferably, the characteristic is softness. The inquiry includes information on a location of use of the power feed mat. The specifying means specifies at least one power feed mat among the plurality of power feed mats based on the information on the location of use and the plurality of categories set for the softness. According to such a configuration, the power feed mat can be rented in accordance with the location of use.

Preferably, the information on the location of use includes information indicating the indoors or the outdoors. When the location of use is the outdoors, the specifying means specifies a power feed mat softer than a power feed mat for the indoors among the plurality of power feed mats. According to such a configuration, the power feed mat suitable for the outdoors can be rented.

Preferably, the characteristic is power feed capability. The inquiry includes information on power feed capability required of the power feed mat by a user of the power feed mat. The specifying means specifies at least one power feed mat among the plurality of power feed mats based on the information on power feed capability required by the user of the power feed mat and the plurality of categories set for the power feed capability. According to such a configuration, the power feed mat can be rented in accordance with power feed capability required by the user.

Preferably, the characteristic is a frequency of failure. The inquiry includes information on an industry of a user of the power feed mat. The specifying means specifies at least one power feed mat among the plurality of power feed mats based on the information on the industry and the plurality of categories set for the frequency of failure.

According to such a configuration, the power feed mat low in frequency of failure can be rented to a user who is in an industry in which failure of the power feed mat leads to great damage. Therefore, occurrence of great damage can be suppressed.

Preferably, the characteristic is a degree of soiling. The acceptance means further accepts user information indicating whether a user of the power feed mat falls under an individual or a corporate. When the user falls under the individual, the specifying means specifies a power feed mat lower in degree of soiling than a power feed mat for the corporate among the plurality of power feed mats. In general, an individual is more sensitive to soling than a corporate. Therefore, the power feed mat in accordance with a type of the user can be rented.

Preferably, the characteristic is a frequency of failure or a degree of deterioration. The inquiry includes type information indicating a type of a movable body that is fed power by the power feed mat. When the type information indicates a movable body for emergency or disasters, the specifying means specifies a power feed mat lower in frequency of failure or lower in degree of deterioration than when the type information does not indicate the movable body for emergency or disasters among the plurality of power feed mats.

According to such a configuration, the power feed mat low in frequency of failure or low in degree of deterioration can be rented to a user of the movable body for emergency or disasters. In other words, a highly reliable power feed mat can be rented to the user who requires high reliability of the power feed mat.

Preferably, the acceptance means accepts the inquiry from a terminal device communicatively connected to the information processing apparatus. The output means gives information based on the result of specifying to the terminal device.

According to such a configuration, on the terminal device, an inquiry about rental can be made and information based on the specified power feed mat can be checked.

According to another aspect of the present disclosure, an information processing system includes the information processing apparatus described above and the terminal device described above.

According to such a configuration, the power feed mat can appropriately be rented to a user who has made the inquiry.

According to yet another aspect of the present disclosure, an information processing method includes accepting, by an information processing apparatus, an inquiry about rental of a power feed mat that supplies electric power to a movable body and specifying, by the information processing apparatus, at least one power feed mat among a plurality of power feed mats based on the accepted inquiry and association information in which category information is associated with identification information of each of the plurality of power feed mats. The category information indicates to which of a plurality of categories set for at least one characteristic of the power feed mat a characteristic belongs. The information processing method further includes providing, by the information processing apparatus, information based on a result of specifying.

According to such a method, the information processing apparatus can specify a power feed mat based on the inquiry, among the plurality of power feed mats. Therefore, the power feed mat can appropriately be rented to a user who has made the inquiry.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a configuration of a wireless charging system including a power feed mat.

FIG. 2 is a diagram illustrating a schematic configuration of an information processing system.

FIG. 3 is a block diagram showing a typical hardware configuration of a server apparatus.

FIG. 4 is a block diagram showing a typical hardware configuration of a terminal device.

FIG. 5 is a functional block diagram for illustrating a functional configuration of the server apparatus and the terminal device included in the information processing system.

FIG. 6 is a diagram for illustrating a schematic configuration of a database stored in the server apparatus.

FIG. 7 is a diagram showing a log-in screen on the terminal device.

FIG. 8 is a diagram showing an input screen for making an inquiry about rental of a power feed mat.

FIG. 9 is a diagram showing a screen of a result of an estimate based on a result of specifying.

FIG. 10 is a sequence diagram for illustrating a flow of processing performed in the information processing system.

### DESCRIPTION OF THE PREFERRED EMBODIMENTS

An embodiment of the present disclosure will be described below in detail with reference to the drawings. The same or corresponding elements in the drawings have the same reference characters allotted and description thereof will not be repeated. In the drawings, illustration is not in accordance with an actual dimensional ratio. For facilitating understanding of a structure, there are illustrations where the ratio is modified to clarify the structure.

<A. Power Feed Mat>

A schematic configuration of a power feed mat to be rented in the present embodiment and exemplary use of the power feed mat will be described.

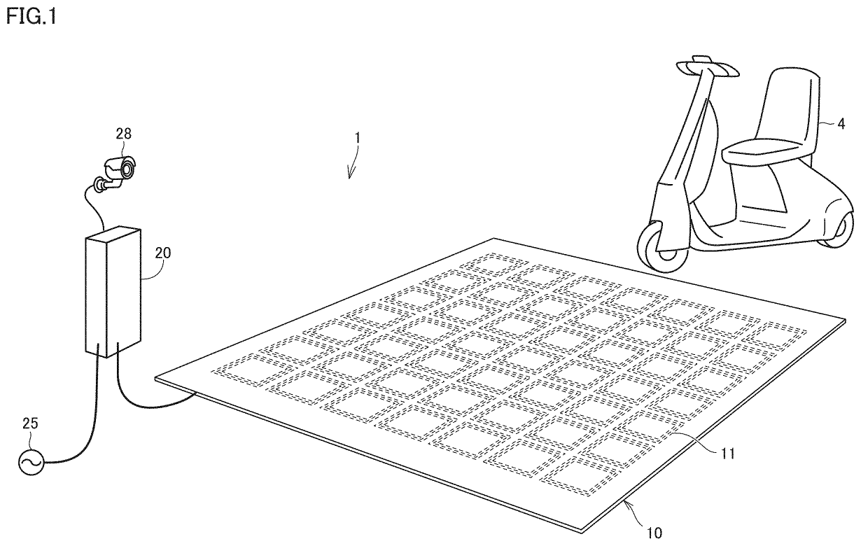

FIG. 1 is a perspective view schematically showing a configuration of a wireless charging system including a power feed mat. As shown in FIG. 1, a power feed mat 10 is used by a movable body 4. Movable body 4 includes a power reception coil and a power storage that are not shown.

Examples of movable body 4 include a vehicle, a micropalette, and an unmanned aerial vehicle (UVA) which is also referred to as a drone. Examples of the vehicle include a small mobility with a seat capacity of one or two passengers as shown in FIG. 1. Without being limited as such, the vehicle may be, for example, a hybrid electric vehicle (HEV), a plug-in hybrid electric vehicle (PHEV), a battery electric vehicle (BEV), or an autonomous vehicle capable of transporting a load without human intervention.

A wireless charging system 1 includes power feed mat 10 and a power feed apparatus 20.

Power feed mat 10 can wirelessly send electric power to movable body 4. Power feed mat 10 may be placed on a road surface or the like or on a wall surface. Power feed mat 10 may be flexible or pliable as being rolled. More specifically, power feed mat 10 includes a plurality of power transmission coils 11. Without being limited as such, power feed mat 10 may include a single power transmission coil 11.

Power transmission coil 11 can wirelessly transmit electric power to a power reception coil mounted on movable body 4. While the power reception coil is located above power transmission coil 11, power transmission coil 11 sends electromagnetic waves for power transmission to that power reception coil. The power reception coil charges a power storage of movable body 4 with electric power generated based on the electromagnetic waves. Power transmission coil 11 may be formed in a quadrangular shape in a plan view as shown in FIG. 1 or in a hexagonal shape in the plan view. Alternatively, power transmission coil 11 may be formed in a shape different from the quadrangular shape and the hexagonal shape in the plan view.

Power feed apparatus 20 supplies electric power to power feed mat 10. Power feed apparatus 20 can be connected to an alternating-current (AC) power supply 25. Power feed apparatus 20 converts a voltage of AC power supplied from AC power supply 25 into an appropriate value and supplies resultant AC power to power feed mat 10.

Power feed apparatus 20 may include a sensor unit 28. Sensor unit 28 detects a position of movable body 4 that passes over power feed mat 10. Sensor unit 28 includes at least one of a camera, a radar, and a laser imaging detection and ranging (LIDAR).

An information processing system for rental of the power feed mat described above will be described below. Though details will be described later, characteristics (for example, a state and performance) of power feed mat 10 are different for each power feed mat 10. Then, in the present first embodiment, power feed mat 10 is rented in consideration of the characteristics of power feed mat 10.

<B. Schematic Configuration of Information System>

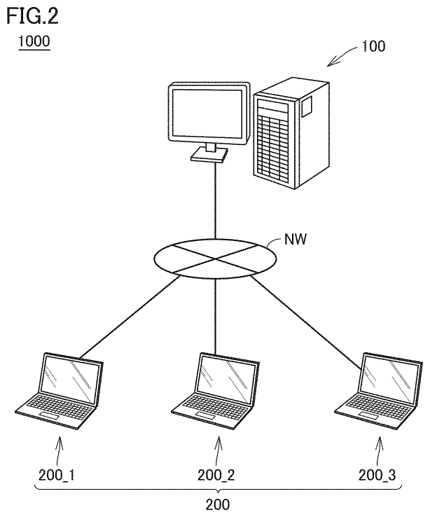

FIG. 2 is a diagram illustrating a schematic configuration of the information processing system in the present embodiment.

As show % n in FIG. 2, an information processing system 1000 includes a server apparatus 100 and a plurality of terminal devices 200_1, 200_2, 200_3, . . . . For the sake of convenience of description, any one terminal device of terminal devices 200_1, 200_2, 200_3, . . . is referred to as a “terminal device 200” below.

Server apparatus 100 and each terminal device 200 are communicatively connected to each other over a network NW. Though FIG. 2 shows three terminal devices 200, the number of terminal devices 200 is not limited thereto.

Server apparatus 100 is, for example, a server of a rental business operator that rents power feed mat 10. Alternatively, server apparatus 100 is a shared server shared by a plurality of business operators including the rental business operator. Alternatively, server apparatus 100 is a cloud server provided by a cloud server management company.

Each terminal device 200 is a communication device used by a user who uses a power feed mat rental service provided by the rental business operator. For example, terminal device 200_1 is used in one company while terminal device 200_2 is used in another company. A business category of a company that uses the rental service is not particularly limited.

<C. Hardware Configuration of Device>

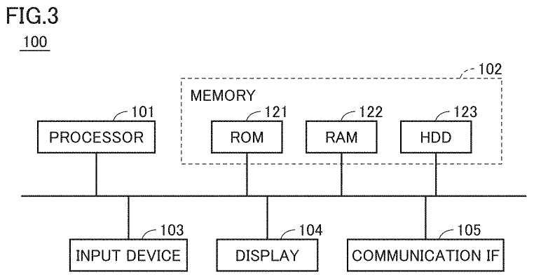

FIG. 3 is a block diagram showing a typical hardware configuration of server apparatus 100.

As shown in FIG. 3, server apparatus 100 includes a processor 101, a memory 102, an input device 103, a display 104, and a communication interface (IF) 105. Memory 102 includes a read only memory (ROM) 121, a random access memory (RAM) 122, and a hard disk drive (HDD) 123.

Processor 101 is communicatively connected to ROM 121, RAM 122. HDD 123, input device 103, display 104, and communication IF 105 through a bus or the like.

Processor 101 controls overall operations of server apparatus 100. Processor 101 executes an operating system and an application program stored in memory 102.

Input device 103 accepts an input from a user. Input device 103 is typically implemented by a keyboard and/or a mouse. Various types of information are shown on display 104. Communication IF 105 is an interface for communication with each terminal device 200.

Server apparatus 100 may include another non-volatile storage (for example, a solid state drive (SSD)) instead of or together with HDD 123.

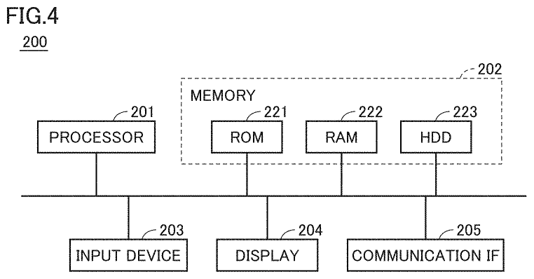

FIG. 4 is a block diagram showing a typical hardware configuration of terminal device 200.

As shown in FIG. 4, terminal device 200 includes a processor 201, a memory 202, an input device 203, a display 204, and a communication IF 205. Memory 202 includes a ROM 221, a RAM 222, and an HDD 223.

Processor 201 is communicatively connected to ROM 221, RAM 222, HDD 223, input device 203, display 204, and communication IF 205 through a bus or the like.

Processor 201 controls overall operations of terminal device 200. Processor 201 executes an operating system and an application program stored in memory 202.

Input device 203 accepts an input from a user. Input device 203 is typically implemented by a keyboard and/or a mouse. Various types of information are shown on display 204. Communication IF 205 is an interface for communication with server apparatus 100.

Similarly to server apparatus 100, terminal device 200 may include another non-volatile storage (for example, an SSD) instead of or together with HDD 223.

<D. Functional Configuration of System>

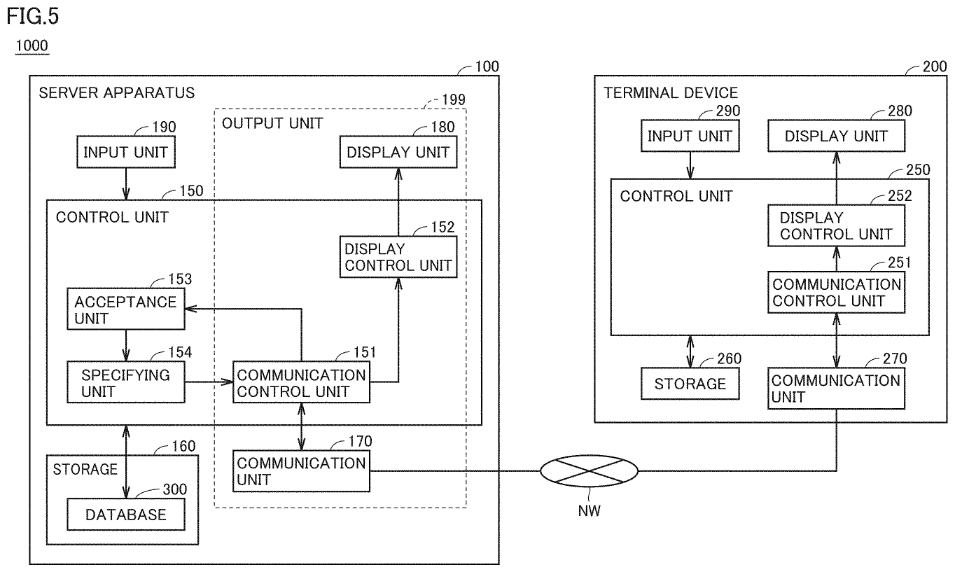

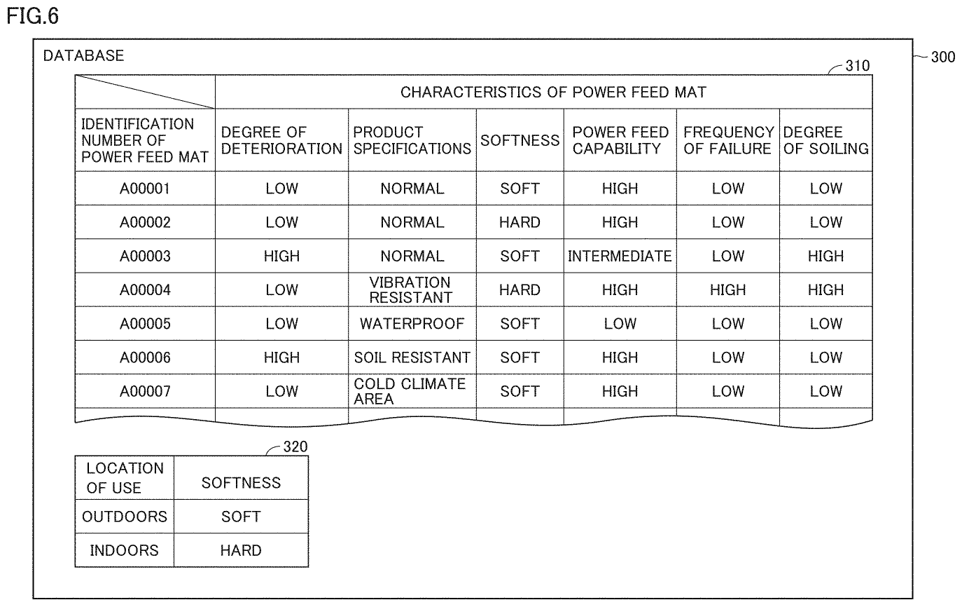

FIG. 5 is a functional block diagram for illustrating a functional configuration of server apparatus 100 and terminal device 200 included in information processing system 1000. FIG. 6 is a diagram for illustrating a schematic configuration of a database stored in server apparatus 100.

(d1. Terminal Device 200)

As shown in FIG. 5, terminal device 200 includes a control unit 250, a storage 260, a communication unit 270, a display unit 280, and an input unit 290. Control unit 250 includes a communication control unit 251 and a display control unit 252.

Control unit 250 controls overall operations of terminal device 200. Control unit 250 is a functional block implemented by execution by processor 201, of an operating system and an application program stored in memory 202.

Communication control unit 251 controls communication with the outside (server apparatus 100 in the present example) through communication unit 270. Communication unit 270 corresponds to communication IF 205 in FIG. 4.

Display control unit 252 controls screen display on display unit 280. Display unit 280 corresponds to display 204 in FIG. 4.

Input unit 290 accepts an input operation from a user of terminal device 200. Input unit 290 sends a signal based on an input operation to control unit 250. Input unit 290 corresponds to input device 203 in FIG. 4.

An operating system and an application program are stored in storage 260. Storage 260 corresponds to memory 202 in FIG. 4. In the present example, a web browser or the like is stored as the application program.

Data on rental of power feed mat 10 is transmitted through communication unit 270 and network NW in accordance with an operation by the user through input unit 290. For example, an ID of the user, a password of the user, inquiry data for an estimate, and data (signal) for placing a firm order are transmitted from terminal device 200 to server apparatus 100.

Terminal device 200 receives data from server apparatus 100 through network NW and communication unit 270. Terminal device 200 receives a response signal from server apparatus 100 in accordance with a request signal from terminal device 200.

Terminal device 200 typically receives data (an HTML file, image data, or the like) for showing a web page from server apparatus 100. Specifically, data for showing a web page for logging into server apparatus 100, data for showing a data input web page for an estimate, data for showing a web page for placing a firm order (for a formal order and for making a firm reservation), or the like is received from server apparatus 100. An exemplary screen shown on terminal device 200 will be described later.

(d2. Server Apparatus 100)

Server apparatus 100 includes a control unit 150, a storage 160, a communication unit 170, a display unit 180, and an input unit 190. Control unit 150 includes a communication control unit 151, a display control unit 152, an acceptance unit 153, and a specifying unit 154. A database 300 is stored in storage 160. An output unit 199 includes communication control unit 151, communication unit 170, display control unit 152, and display unit 180.

Control unit 150 controls overall operations of server apparatus 100. Control unit 150 is a functional block implemented by execution by processor 101, of an operating system and an application program stored in memory 102.

Communication control unit 151 controls communication with the outside (terminal device 200 in the present example) through communication unit 170. Communication unit 170 corresponds to communication IF 105 in FIG. 3.

Display control unit 152 controls screen display on display unit 180. Display unit 180 corresponds to display 104 in FIG. 3.

Input unit 190 accepts an input operation from a user of server apparatus 100. Input unit 190 sends a signal based on an input operation to control unit 150. Input unit 190 corresponds to input device 103 in FIG. 3.

An operating system, an application program, and database 300 are stored in storage 160. Storage 160 corresponds to memory 102 in FIG. 3.

As shown in FIG. 6, database (association information) 300 includes a data table 310 and a data table 320.

In data table 310, category information is associated with identification information of each of a plurality of power feed mats 10. The category information indicates to which of a plurality of categories (characteristic categories) set for characteristics each characteristic of power feed mat 10 belongs. Each of the plurality of categories (a plurality of segments) set for any one characteristic indicates a group, a rank, a level, a grade, or a class to which one power feed mat 10 belongs in connection with that characteristic.

With attention being paid to such a characteristic (an item) as a “degree of deterioration,” the category information “low” is associated with identification information “A00001” of power feed mat 10. Specifically, the category information indicates that the degree of deterioration of power feed mat 10 with identification information “A00001” belongs to “low” of the plurality of categories (“high” and “low”). The category information “high” is associated with identification information “A00003” of the power feed mat. Specifically, the category information indicates that the degree of deterioration of power feed mat 10 with identification information “A00003” belongs to “high” of the plurality of categories (“high” and “low”).

The degree of deterioration in the present example is a concept referring to the degree of deterioration of performance of power feed mat 10 and not including a degree of soiling which will be described later.

With attention being paid to such a characteristic (an item) as “product specifications,” the category information “normal” is associated with identification information “A00001” of power feed mat 10. Specifically, the category information indicates that the product specifications of power feed mat 10 with identification information “A00001” belong to “normal” of the plurality of categories (“normal”. “vibration resistant,” “waterproof”, “soil resistant”, and “cold climate area”). The cold climate area specification refers to a specification with a function to melt snow by current conduction to a heater or a coil.

Similarly, the category information “vibration resistant” is associated with identification information “A00004” of power feed mat 10. The category information “waterproof” is associated with identification information “A00005” of power feed mat 10. The category information “soil resistant” is associated with identification information “A00006” of power feed mat 10. The category information “cold climate area” is associated with identification information “A00007” of power feed mat 10.

With attention being paid to such a characteristic (an item) as “softness”, the category information “soft” is associated with identification information “A00001” of power feed mat 10. Specifically, the category information indicates that softness of power feed mat 10 with identification information “A00001” belongs to “soft” of the plurality of categories (“soft” and “hard”). Similarly, the category information “hard” is associated with identification information “A00002” of power feed mat 10.

With attention being paid to such a characteristic (an item) as “power feed capability.” the category information “high” is associated with identification information “A00001” of power feed mat 10. Specifically, the category information indicates that power feed capability of power feed mat 10 with identification information “A00001” belongs to “high” of the plurality of categories (“high”, “intermediate”, and “low”). Similarly, the category information “intermediate” is associated with identification information “A00003” of power feed mat 10. The category information “low” is associated with identification information “A00005” of power feed mat 10.

With attention being paid to such a characteristic (an item) as a “frequency of failure,” the category information “low” is associated with identification information “A00001” of power feed mat 10. Specifically, the category information indicates that the frequency of failure of power feed mat 10 with identification information “A00001” belongs to “low” of the plurality of categories (“low” and “high”). Similarly, the category information “high” is associated with identification information “A00004” of power feed mat 10.

With attention being paid to such a characteristic (an item) as a “degree of soiling,” the category information “low” is associated with identification information “A00001” of power feed mat 10. Specifically, the category information indicates that the degree of soiling of power feed mat 10 with identification information “A00001” belongs to “low” of the plurality of categories (“high” and “low”). Similarly, the category information “high” is associated with identification information “A00003” of power feed mat 10.

Furthermore, flag information (not shown) indicating whether or not a power feed mat has already been rented is brought in correspondence with identification information of power feed mat 10. When the power feed mat has already been rented, information on a day of rental and information on a scheduled day of return are further brought in correspondence.

Flag information indicating whether or not rental of a power feed mat is scheduled is brought in correspondence with the identification information of power feed mat 10. When rental of a power feed mat has been scheduled (reserved), information on a scheduled day of start of rental and information on a scheduled day of return are further brought in correspondence.

In data table 320, information on a location of use of power feed mat 10 and information on softness of power feed mat 10 are brought in correspondence with each other. In the present example, “soft” representing the information on softness is brought in correspondence with “outdoors” representing the location of use. “Hard” representing the information on softness is brought in correspondence with “indoors” representing the location of use.

Referring again to FIG. 5, acceptance unit 153 accepts an inquiry about rental of power feed mat 10. Acceptance unit 153 accepts an inquiry about rental of power feed mat 10 from terminal device 200 through communication unit 170 and communication control unit 151. When acceptance unit 153 accepts an inquiry about rental, acceptance unit 153 notifies specifying unit 154 of the accepted inquiry.

Specifying unit 154 specifies at least one power feed mat 10 among the plurality of power feed mats 10 managed by server apparatus 10 based on the inquiry accepted by acceptance unit 153 and database 300. A specific specifying method will be described after explanation of an exemplary screen shown on terminal device 200.

Output unit 199 provides output of a result of specifying by specifying unit 154. Typically, output unit 199 (in particular, communication control unit 151 and communication unit 170) transmits a result of specifying to terminal device 200 from which the inquiry was made. Output unit 199 (in particular, display control unit 152 and display unit 180) shows the result of specifying.

Furthermore, acceptance unit 153 accepts an instruction to place a firm order from terminal device 200 through communication unit 170 and communication control unit 151. The firm order of power feed mat 10 is thus placed. When the firm order is placed, control unit 150 transmits data indicating placement of the firm order (data for showing a web page) to terminal device 200 that placed the order.

<E. User Interface of Terminal Device>

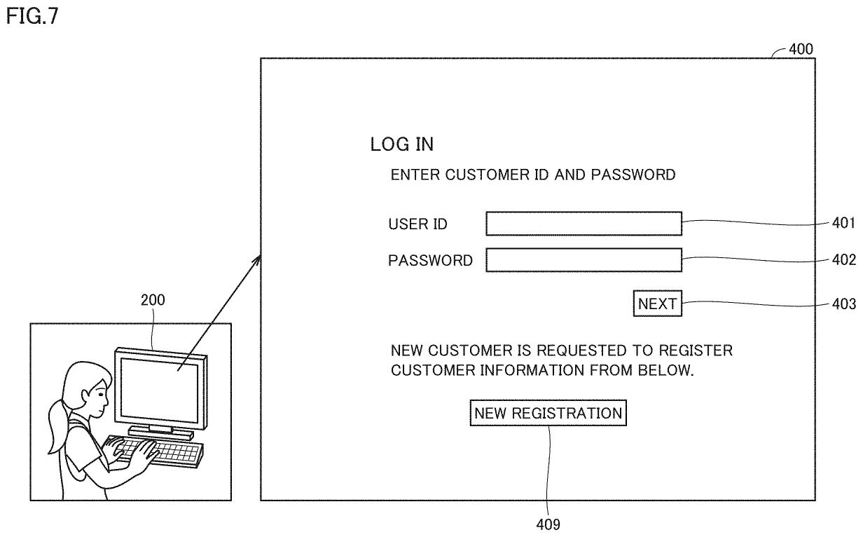

FIG. 7 is a diagram showing a log-in screen on terminal device 200.

As shown in FIG. 7, a log-in screen 400 includes a field 401 of entry of a user ID, a field 402 of entry of a password, a button 403 for transition to a next screen, and a button 409 for transition to a screen for new registration. Buttons 403 and 409 are graphical user interface (GUI) buttons.

When user registration has already been made, the user enters the user ID into field 401 and enters the password into field 402. Thereafter, the user selects button 403. The user ID and the password are thus transmitted to server apparatus 100. Thus, in server apparatus 100, user authentication is performed.

When the user uses a power feed mat 10 rental service for the first time, the user makes user registration by selecting button 409. In information processing system 1000, at the time of new registration of the user, entry of information indicating a name of the user (for example, a name of an individual or a corporate) or an industry of the user is accepted.

When authentication is successful, the user is uniquely specified in server apparatus 100. Server apparatus 100 can determine whether the user falls under an individual or a corporate by specifying the user and can specify also an industry of the user. Such information is used in specifying power feed mat 10.

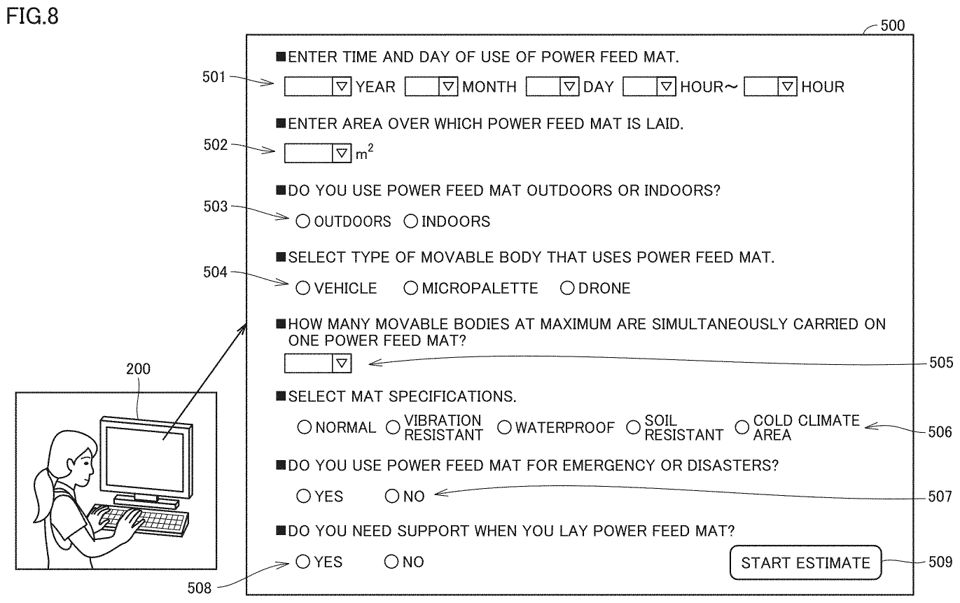

FIG. 8 is a diagram showing an input screen for making an inquiry about rental of power feed mat 10. FIG. 8 also shows a screen for obtaining an estimate of rental of power feed mat 10.

As shown in FIG. 8, an input screen 500 includes an input field 501 for entry of a period of use, an input field 502 for entry of an area over which power feed mat 10 is laid, and a radio button 503 for designating whether power feed mat 10 is used outdoors or indoors. Input screen 500 further includes a radio button 504 for selecting a movable body that uses power feed mat 10, a pull-down menu 505 for designating how many movable bodies at the maximum are carried on one power feed mat 10, and a radio button 506 for selecting a specification of power feed mat 10. Input screen 500 further includes a radio button 507 for designating whether the movable body is for emergency or for disasters, a radio button 508 for designating whether or not support is required for laying power feed mat 10, and a GUI button 509 for indicating start of an estimate.

In the present example, power feed mats 10 are assumed as being identical in size (longitudinal and lateral sizes). The number of necessary power feed mats 10 can be determined based on the area over which power feed mat 10 is laid. Power feed mats 10 do not necessarily have to be identical in size. In such a case, information on the size of the power feed mat should only be brought in correspondence with the identification information of power feed mat 10 in data table 310.

Items in input screen 500 for making an inquiry about rental are not limited as above. For example, input screen 500 may include information on a price plan. For example, an item designating any one of a high-performance plan for rental of a high-performance power feed mat and a normal plan for rental of a normal-performance power feed mat may be included. When power feed mat 10 in a single size is available, input of the number of power feed mats 10 instead of the area may be accepted. When power feed mats 10 in a plurality of sizes are available, input designating the size and input of the number of power feed mats may be accepted.

The user of terminal device 200 enters each item in input screen 500, and thereafter selects button 509. Then, information on each item entered in input screen 500 is transmitted to server apparatus 10.

Server apparatus 100 specifies power feed mat 10 to be rented to the user among the plurality of power feed mats 10 managed thereby, based on information on the user and information entered in input screen 500. Server apparatus 10 gives information based on a result of specifying to terminal device 200. Specifically, server apparatus 100 makes an estimate of power feed mat 10 and notifies terminal device 200 of a result of the estimate.

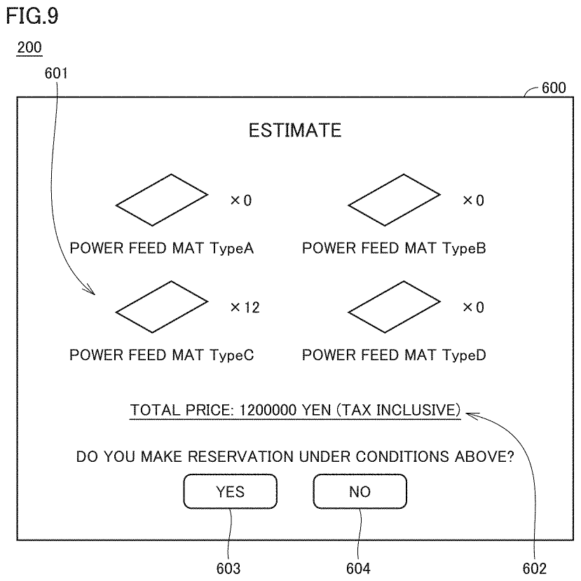

FIG. 9 is a diagram showing a screen of a result of an estimate based on a result of specifying.

As shown in FIG. 9, terminal device 200 shows a screen 600 including information 601 including a type of power feed mat 10 and the number of power feed mats, information 602 on a total amount, a button 603 for making a reservation, and a button 604 for not making a reservation. Screen 600 may include information on a period of use or the like.

When the user selects button 603, reservation of power feed mat 10 is completed in server apparatus 100.

<F. Processing for Specifying Power Feed Mat>

Server apparatus 100 recognizes whether the user falls under an individual or a corporate. Server apparatus 100 recognizes also an industry of the user.

An inquiry from the user includes information on a period of use, information on an area, information on a location of use (indoors or outdoors), a type of the movable body, and information on the number of movable bodies carried on power feed mat 10 as described above. The inquiry is assumed to include information on a price plan described above.

Server apparatus 100 specifies at least one power feed mat 10 among the plurality of power feed mats 10 managed thereby, based on the recognized information and the information included in the inquiry. Server apparatus 100 specifies power feed mat 10 that conforms to such information. Server apparatus 100 specifies power feed mat 10 that meets at least a request from the user. When power feed mats 10 that meet the request from the user are not sufficiently available, server apparatus 100 may select power feed mat 10 higher in spec. Specifying processing will be described below with reference to a plurality of examples.

(1) When a high-performance plan is selected in input screen 500, server apparatus 100 specifies power feed mat 10 at least “low” in degree of deterioration among the plurality of power feed mats 10, by referring to data table 310. When the normal plan is selected, server apparatus 100 specifies the power feed mat “high” or “low” in degree of deterioration without restriction in connection with such a degree of deterioration. When the normal plan is selected, server apparatus 100 may preferentially select power feed mat 10 “high” in degree of deterioration.

(2) When the outdoors is selected in input screen 500, server apparatus 100 specifies at least soft power feed mat 10 among the plurality of power feed mats 10, by referring to data table 310 and data table 320. When the indoors is selected, server apparatus 100 specifies at least hard power feed mat 10 among the plurality of power feed mats 10, by referring to data table 310 and data table 320.

In general, a road surface outdoors is rougher than a road surface indoors. Therefore, for outdoor use, server apparatus 100 specifies soft power feed mat 10.

(3) When the vehicle is selected in input screen 500, server apparatus 100 specifies power feed mat 10 with power feed capability that meets a requested amount of power feed among the plurality of power feed mats 10 by referring to data table 310, the number of vehicles simultaneously carried on power feed mat 10 entered in input screen 500, and information on the amount of power feed requested for one vehicle.

For example, when the number of vehicles is equal to or larger than a threshold value Th1, server apparatus 100 specifies power feed mat 10 with “high” power feed capability. When the number of vehicles is smaller than threshold value Th1 and equal to or larger than a threshold value Th2, server apparatus 100 specifies power feed mat 10 with “intermediate” power feed capability. When the number of vehicles is smaller than threshold value Th2, server apparatus 100 specifies power feed mat 10 with “low” power feed capability.

Similarly, when the micropalette is selected in input screen 500, server apparatus 100 specifies power feed mat 10 with power feed capability that meets a requested amount of power feed among the plurality of power feed mats 10 by referring to data table 310, the number of micropalettes simultaneously carried on power feed mat 10 entered in input screen 500, and information on the amount of power feed requested for one micropalette.

When the drone is selected in input screen 500, server apparatus 100 specifies power feed mat 10 with power feed capability that meets a requested amount of power feed among the plurality of power feed mats 10 by referring to data table 310, the number of drones simultaneously carried on power feed mat 10 entered in input screen 500, and information on the amount of power feed requested for one drone.

Server apparatus 100 may specify power feed mat 10 based on information on only one of the type of the movable body and the number of movable bodies 4 simultaneously carried on power feed mat 10.

(4) When an industry of an authenticated user falls under a specific industry, server apparatus 100 specifies power feed mat 10 at least “low” in frequency of failure among the plurality of power feed mats 10 by referring to data table 310. For example, for a business operator expected to suffer from great damages in the event of stop of power feed to the vehicle, such as a business operator that handles fresh food, server apparatus 100 specifies power feed mat 10 at least “low” in frequency of failure.

(5) When the authenticated user falls under an individual, server apparatus 100 specifies power feed mat 10 at least “low” in degree of soiling among the plurality of power feed mats 10 by referring to data table 310. When the authenticated user falls under a corporate, server apparatus 100 specifies the power feed mat “high” or “low” in degree of soiling without restriction in connection with such a degree of soiling. When the authenticated user falls under the corporate, server apparatus 100 may preferentially select power feed mat 10 “high” in degree of soiling.

(6) When the item emergency or disasters is selected in input screen 500, server apparatus 100 specifies power feed mat 10 at least “low” in frequency of failure among the plurality of power feed mats 10 by referring to data table 310. Alternatively, server apparatus 100 specifies power feed mat 10 at least “low” in degree of deterioration among the plurality of power feed mats 10 by referring to data table 310.

Without being limited as such, server apparatus 100 may specify power feed mat 10 at least “low” in frequency of failure and “low” in degree of deterioration.

More specifically, server apparatus 100 narrows down power feed mats 10 to be rented to the user from among the plurality of power feed mats 10 based on information entered into input screen 500. For example, when items the “high-performance plan,” “outdoors”, the “vehicle”, “10”, “vibration resistant,” and the “item for emergency or disasters” are selected in input screen 500 and the industry of the authenticated user falls under the “specific industry” and the “corporate”, server apparatus 100 specifies power feed mat 10 that meets these requirements among the plurality of power feed mats 10 under the condition described above. For example, server apparatus 100 specifies power feed mat 10 at least “low” in degree of deterioration, “soft” in softness, “high” in power feed capability, “vibration resistant” in product specifications, and “low” in frequency of failure.

<G. Update of Data Table 310>

Data table 310 is updated automatically or manually. Each category in data table 310 is updated. Information on new power feed mat 10 is added to data table 310.

With progress of deterioration of power feed mat 10, the category of the degree of deterioration is updated in data table 310. With progress of deterioration of power feed mat 10, the category of the degree of deterioration is changed, for example, from “low” to “high”.

The degree of deterioration can be determined by the number of times of use of power feed mat 10. The degree of deterioration can be determined by a ratio of utilization of power feed mat 10. The degree of deterioration can also be determined by a total time period of transport of power feed mat 10. The degree of deterioration can also be determined by a weight (an amount of increase in weight) of power feed mat 10. The degree of deterioration can also be determined by soiling of power feed mat 10. The degree of deterioration can also be determined based on the number of times or a frequency of cleaning of power feed mat 10.

The degree of deterioration can also be determined based on the type of the movable body that travels over power feed mat 10. The degree of deterioration can also be determined based on the type of the movable body entered into inquiry input screen 500 shown in FIG. 8.

A power feed mat 10 rental service provider (a manager or the like of the power feed mat) may determine the degree of deterioration of power feed mat 10 by measuring, with the use of a measurement instrument, efficiency in power feed of returned power feed mat 10. In this case, an instrument for measurement or the like rather than the user may determine the degree of deterioration.

Server apparatus 100 may determine the degree of deterioration by receiving an amount of power feed from movable body 4 and estimating efficiency in power feed.

<H. Processing Sequence>

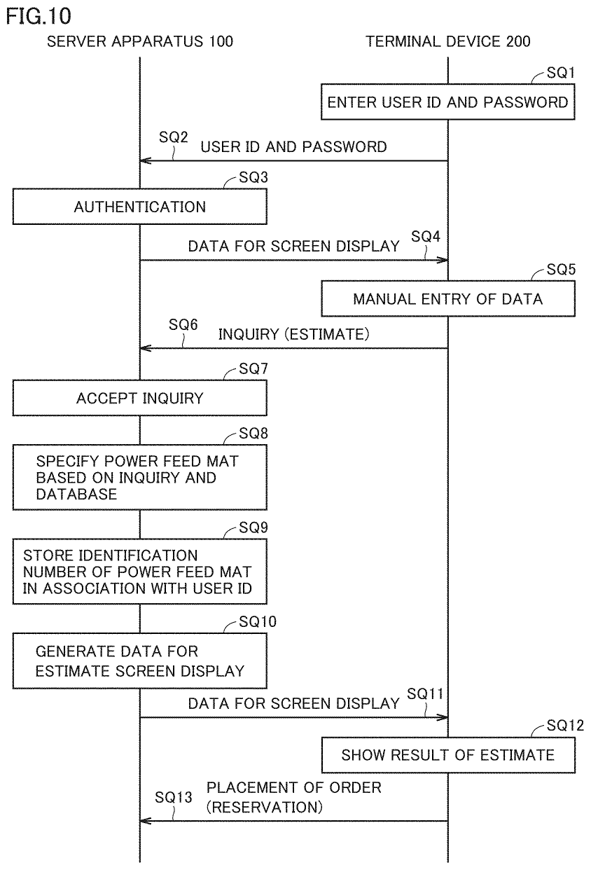

FIG. 10 is a sequence diagram for illustrating a flow of processing performed in information processing system 1000. For the sake of convenience of description, processing after log-in screen 400 shown in FIG. 7 is shown on terminal device 200 will be described below.

As shown in FIG. 10, in sequence SQ1, terminal device 200 accepts entry of a user ID and a password. In sequence SQ2, terminal device 200 transmits the user ID and the password to server apparatus 100. In sequence SQ3, server apparatus 100 authenticates the user of terminal device 200 based on the received user ID and password.

In sequence SQ4, server apparatus 100 transmits data for showing inquiry input screen 500 (data for screen display) to terminal device 200. Specifically, server apparatus 100 transmits data for showing a web page to terminal device 200. In sequence SQ5, after input screen 500 is shown, terminal device 200 accepts inquiry data input into input screen 500 (see FIG. 8).

In sequence SQ6, terminal device 200 transmits inquiry information to server apparatus 100. Specifically, being triggered by selection of button 509 shown in FIG. 8, terminal device 200 transmits inquiry information to server apparatus 100.

In sequence SQ7, server apparatus 100 accepts the inquiry about rental of power feed mat 10. In sequence SQ8, server apparatus 100 specifies at least one power feed mat 10 among the plurality of power feed mats 10 based on the inquiry and database 300 (FIG. 6).

In sequence SQ9, server apparatus 100 has the user ID stored in association with identification information of power feed mat 10. Specifically, server apparatus 100 associates the user ID and the information on a period of use with the identification information of power feed mat 10.

In sequence SQ10, server apparatus 100 generates data for showing an estimate on terminal device 200 (data for screen display). In sequence SQ11, server apparatus 100 transmits the generated data for screen display to terminal device 200.

In sequence SQ12, terminal device 200 shows screen 600 showing a result of the estimate (see FIG. 9). In sequence SQ13, being triggered by selection of button 603 (FIG. 9) for making a reservation, terminal device 200 issues an order to server apparatus 100.

Thereafter, at prescribed timing, the manager of power feed mat 10 performs processing for bringing power feed mat 10 specified by server apparatus 100 from a location of storage of power feed mat 10 and delivering the power feed mat to the user.

Through such a series of processing, power feed mat 10 is rented to the user.

<I. Summary>

An illustrative embodiment described above is understood by a person skilled in the art as specific examples of aspects below.

(1) Server apparatus 100 representing an exemplary information processing apparatus includes acceptance unit 153 that accepts an inquiry about rental of power feed mat 10 that supplies electric power to movable body 4 and storage 160 in which database 300 (association information) in which category information is associated with identification information of each of a plurality of power feed mats 10 is stored. The category information indicates to which of a plurality of categories set for characteristics at least one characteristic of power feed mat 10 belongs. Server apparatus 100 further includes specifying unit 154 that specifies at least one power feed mat among the plurality of power feed mats 10 based on the inquiry accepted by acceptance unit 153 and database 300 and output unit 199 that provides information based on a result of specifying by specifying unit 154.

According to such a configuration, server apparatus 100 can specify a power feed mat based on the inquiry among the plurality of power feed mats 10. Therefore, the power feed mat can appropriately be rented to a user who has made the inquiry.

(2) The characteristic is a degree of deterioration. The plurality of categories set for the degree of deterioration include a category (for example, “high”) in which the degree of deterioration of power feed mat 10 is equal to or higher than a reference degree and a category (for example, “low”) in which the degree of deterioration is lower than the reference degree. According to such a configuration, power feed mat 10 can be rented in accordance with the degree of deterioration.

(3) The characteristic is a product specification. The inquiry includes information indicating the product specification. According to such a configuration, power feed mat 10 can be rented in accordance with the product specification.

(4) The characteristic is softness. The inquiry includes information on a location of use of power feed mat 10. Specifying unit 154 specifies at least one power feed mat 10 among the plurality of power feed mats 10 based on the information on the location of use and the plurality of categories (for example, “soft” and “hard”) set for the softness. According to such a configuration, power feed mat 10 can be rented in accordance with the location of use.

(5) The information on the location of use includes information indicating the indoors or the outdoors. When the location of use is the outdoors, specifying unit 154 specifies power feed mat 10 softer than power feed mat 10 for the indoors among the plurality of power feed mats 10. According to such a configuration, power feed mat 10 suitable for the outdoors can be rented.

(6) The characteristic is power feed capability. The inquiry includes information on power feed capability required of power feed mat 10 by a user of the power feed mat. Specifying unit 154 specifies at least one power feed mat 10 among the plurality of power feed mats 10 based on the information on power feed capability required by the user of power feed mat 10 and the plurality of categories (for example, “high”, “intermediate”, and “low”) set for the power feed capability. According to such a configuration, power feed mat 10 can be rented in accordance with power feed capability required by the user.

(7) The characteristic is a frequency of failure. The inquiry includes information on an industry of a user of power feed mat 10. Specifying unit 154 specifies at least one power feed mat 10 among the plurality of power feed mats 10 based on the information on the industry and the plurality of categories (for example, “low” and “high”) set for the frequency of failure.

According to such a configuration, power feed mat 10 low in frequency of failure can be rented to a user who is in an industry in which failure of power feed mat 10 leads to great damage. Therefore, occurrence of great damage can be suppressed.

(8) The characteristic is a degree of soiling. Acceptance unit 153 further accepts user information indicating whether a user of power feed mat 10 falls under an individual or a corporate. When the user falls under the individual, specifying unit 154 specifies power feed mat 10 lower in degree of soiling than when the user falls under the corporate among the plurality of power feed mats 10. In general, an individual is more sensitive to soiling than a corporate. Therefore, power feed mat 10 can be rented in accordance with a type of the user.

(9) The characteristic is a frequency of failure or a degree of deterioration. The inquiry includes type information indicating a type of movable body 4 that is fed power by power feed mat 10. When the type information indicates movable body 4 for emergency or disasters, specifying unit 154 specifies power feed mat 10 lower in frequency of failure or lower in degree of deterioration than when the type information does not indicate movable body 4 for emergency or disasters among the plurality of power feed mats 10.

According to such a configuration, power feed mat 10 low in frequency of failure or low in degree of deterioration can be rented to a user of movable body 4 for emergency or disasters. In other words, highly reliable power feed mat 10 can be rented to the user who requires high reliability of power feed mat 10.

(10) Acceptance unit 153 accepts the inquiry from terminal device 200 communicatively connected to server apparatus 100. Output unit 199 gives information based on the result of specifying to terminal device 200. According to such a configuration, on terminal device 200, an inquiry about rental can be made and information based on specified power feed mat 10 can be checked.

(11) An information processing method includes accepting, by server apparatus (information processing apparatus) 100, an inquiry about rental of power feed mat 10 that supplies electric power to movable body 4 and specifying, by server apparatus 100, at least one power feed mat 10 among a plurality of power feed mats 10 based on the accepted inquiry and association information in which category information is associated with identification information of each of the plurality of power feed mats 10. The category information indicates to which of a plurality of categories set for at least one characteristic of power feed mat 10 a characteristic belongs. The information processing method further includes providing, by server apparatus 100, information based on a result of specifying.

According to such a configuration, server apparatus 100 can specify a power feed mat based on the inquiry among the plurality of power feed mats 10. Therefore, the power feed mat can appropriately be rented to a user who has made the inquiry.

(12) A program causes processor 101 of server apparatus 100 to perform accepting an inquiry about rental of power feed mat 10 that supplies electric power to movable body 4 and specifying at least one power feed mat 10 among a plurality of power feed mats 10 based on the accepted inquiry and association information in which category information is associated with identification information of each of the plurality of power feed mats 10. The category information indicates to which of a plurality of categories set for characteristics at least one characteristic of power feed mat 10 belongs. The program further causes processor 101 to perform providing information based on a result of specifying.

According to such a configuration, server apparatus 100 can specify a power feed mat based on the inquiry among the plurality of power feed mats 10. Therefore, the power feed mat can appropriately be rented to a user who has made the inquiry.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. An information processing apparatus comprising:
acceptance means for accepting an inquiry about rental of a power feed mat that supplies electric power to a movable body;
storage means in which association information in which category information is associated with identification information of each of a plurality of power feed mats is stored, the category information indicating to which of a plurality of categories set for characteristics at least one characteristic of the power feed mat belongs;
specifying means for specifying at least one power feed mat among the plurality of power feed mats based on the inquiry accepted by the acceptance means and the association information; and
output means for providing information based on a result of specifying by the specifying means.

2. The information processing apparatus according to claim 1, wherein
the characteristic is a degree of deterioration, and
the plurality of categories set for the degree of deterioration include a category in which the degree of deterioration of the power feed mat is equal to or higher than a reference degree and a category in which the degree of deterioration is lower than the reference degree.

3. The information processing apparatus according to claim 1, wherein
the characteristic is a product specification, and
the inquiry includes information indicating the product specification.

4. The information processing apparatus according to claim 1, wherein
the characteristic is softness,
the inquiry includes information on a location of use of the power feed mat, and
the specifying means specifies at least one power feed mat among the plurality of power feed mats based on the information on the location of use and the plurality of categories set for the softness.

5. The information processing apparatus according to claim 4, wherein
the information on the location of use includes information indicating indoors or outdoors, and
when the location of use is the outdoors, the specifying means specifies a power feed mat softer than a power feed mat for the indoors among the plurality of power feed mats.

6. The information processing apparatus according to claim 1, wherein
the characteristic is power feed capability,
the inquiry includes information on power feed capability required of the power feed mat by a user of the power feed mat, and
the specifying means specifies at least one power feed mat among the plurality of power feed mats based on the information on power feed capability required by the user of the power feed mat and the plurality of categories set for the power feed capability.

7. The information processing apparatus according to claim 1, wherein
the characteristic is a frequency of failure,
the inquiry includes information on an industry of a user of the power feed mat, and
the specifying means specifies at least one power feed mat among the plurality of power feed mats based on the information on the industry and the plurality of categories set for the frequency of failure.

8. The information processing apparatus according to claim 1, wherein
the characteristic is a degree of soiling,
the acceptance means further accepts user information indicating whether a user of the power feed mat falls under an individual or a corporate, and
when the user falls under the individual, the specifying means specifies a power feed mat lower in degree of soiling than a power feed mat for the corporate among the plurality of power feed mats.

9. The information processing apparatus according to claim 1, wherein
the characteristic is a frequency of failure or a degree of deterioration,
the inquiry includes type information indicating a type of a movable body that is fed power by the power feed mat, and
when the type information indicates a movable body for emergency or disasters, the specifying means specifies a power feed mat lower in frequency of failure or lower in degree of deterioration than when the type information does not indicate the movable body for emergency or disasters among the plurality of power feed mats.

10. The information processing apparatus according to claim 1, wherein
the acceptance means accepts the inquiry from a terminal device communicatively connected to the information processing apparatus, and
the output means gives information based on the result of specifying to the terminal device.

11. An information processing system comprising:
the information processing apparatus according to claim 10; and
the terminal device.

12. An information processing method comprising:
accepting, by an information processing apparatus, an inquiry about rental of a power feed mat that supplies electric power to a movable body;
specifying, by the information processing apparatus, at least one power feed mat among a plurality of power feed mats based on the accepted inquiry and association information in which category information is associated with identification information of each of the plurality of power feed mats, the category information indicating to which of a plurality of categories set for at least one characteristic of the power feed mat a characteristic belongs; and
providing, by the information processing apparatus, information based on a result of specifying.
